(19) United States
(12) Patent Application Publication
(10) Pub. No.: US 2025/0044238 A1
(43) Pub. Date: Feb. 6, 2025

(54) ROBOTIC VACUUM CLEANER AND CONTROL METHOD THEREOF

(71) Applicant: SAMSUNG ELECTRONICS CO., LTD., Suwon-si (KR)

(72) Inventors: Jongsoo HONG, Suwon-si (KR); Jeehoon KIM, Suwon-si (KR); Chunseong KIM, Suwon-si (KR)

(73) Assignee: SAMSUNG ELECTRONICS CO., LTD., Suwon-si (KR)

(21) Appl. No.: 18/735,570

(22) Filed: Jun. 6, 2024

Related U.S. Application Data
(63) Continuation of application No. PCT/KR2024/006581, filed on May 14, 2024.

(30) Foreign Application Priority Data
Jul. 31, 2023 (KR) 10-2023-0099995

(51) Int. Cl. G01N 21/94; A47L 9/04; A47L 9/28; G01N 21/55

(52) U.S. Cl. CPC G01N 21/94; A47L 9/0466; A47L 9/2805; A47L 9/2847; G01N 21/55

(57) ABSTRACT

A robotic vacuum cleaner according to an embodiment includes a main body forming an outer appearance, a rotation part rotatably disposed on a lower side of the main body, a cleaning member detachably couplable to the rotation part and having at least one reflective pattern provided on a surface thereof, and an optical sensor disposed at a position adjacent to the rotation part, emitting light toward the cleaning member, and obtaining a light reflection amount reflected by the cleaning member, and the at least one reflective pattern has a reflectance different from a remaining region of the surface not provided with reflective pattern.

### CROSS REFERENCE TO RELATED APPLICATIONS

This application is a continuation application, claiming priority under § 365 (c), of an International Application No. PCT/KR2024/006581, filed on May 14, 2024, which is based on and claims from the benefit of Korean patent application number 10-2023-0099995, filed on Jul. 31, 2023, in the Korean Intellectual Property Office, the disclosures of which is incorporated by reference herein in its entirety.

### BACKGROUND

### 1. Field

The disclosure relates to a robotic vacuum cleaner configured to determine a coupling state of a cleaning member through an optical sensor.

### 2. Description of Related Art

A robotic vacuum cleaner is a device that automatically operates within a specified area without a user's manipulation. In general, the robotic vacuum cleaner may be configured to perform an operation of sucking up foreign substances, such as dust accumulated on a surface to be cleaned (e.g., a floor), or wiping foreign substances, such as dirt adsorbed onto the surface to be cleaned. For example, the robotic vacuum cleaner may have a cleaning member (e.g., a wet mop) detachably coupled to its lower part and may rotate the cleaning member to remove the foreign substances adsorbed onto the surface to be cleaned.

### SUMMARY

robotic vacuum cleaner may include an optical sensor configured to emit light to a cleaning member coupled to a lower part thereof and receive a light reflection amount reflected from the cleaning member. The robotic vacuum cleaner may determine a coupling state of the cleaning member by comparing a the light reflection amount (or a value associated with the amount of light reflected) obtained from the optical sensor against a preset amount of light or (a preset value). However, if a fixed preset value is used to determine a coupling state of the cleaning member, an error may occur in determining whether the cleaning member is properly coupled or not, due to noise that may be generated in different environments, caused by, for example, a change in material of a surface.

Various embodiments of the disclosure may provide a robotic vacuum cleaner including an optical sensor and a cleaning member provided with a reflective pattern, and a method of controlling the same.

A robotic vacuum cleaner according to an embodiment of the disclosure may include a main body forming an outer appearance, a rotation part rotatably disposed on an lower side of the main body, a cleaning member detachably couplable to the rotation part and having at least one reflective pattern provided on a surface thereof and an optical sensor disposed at a position adjacent to the rotation part, emitting light toward the cleaning member, and obtaining a light reflection amount reflected by the cleaning member, and the at least one reflective pattern has a reflectance different from that of a remaining region of the surface, in which reflective pattern is not provided.

A method for controlling a robotic vacuum according to an embodiment of the disclosure may include emitting light to a cleaning member provided with a reflective pattern through an optical sensor and detecting an amount of light reflected from the cleaning member through the optical sensor, detecting a pattern change in the light reflection amount by the reflective pattern based on the light reflection amount detected by the optical sensor and determining a state of the cleaning member based on the detected pattern change

A cleaning member detachably coupled to a robotic vacuum cleaner, according to an embodiment of the disclosure, may include a main body including a surface having a first reflectance, and a reflective pattern on the surface and having a second reflectance different from the first reflectance.

Various embodiments of the disclosure may improve accuracy and reliability of a determination by detecting a pattern change in a light reflection amount caused by a reflective pattern of a cleaning member, upon rotation of rotation part and/or the cleaning member, and determining a coupling state of the cleaning member based on the detected pattern change.

Furthermore, a convenience of a user may be improved by detecting a pattern change in a light reflection amount caused by a reflective pattern of a cleaning member, upon rotation of rotation part and/or the cleaning member, determining whether the cleaning member need to be replaced in consideration of the detected pattern change, and notifying the user of the determination.

Effects that are obtainable from example embodiments of the disclosure may be clearly derived and understood from the following description by those having ordinary knowledge in the technical field to which the embodiments of the disclosure belong. In other words, unintended effects in practicing the example embodiments of the disclosure may be also derived by those having ordinary knowledge in the technical field from the embodiments of the disclosure.

### BRIEF DESCRIPTION OF THE DRAWINGS

In conjunction with the description of the drawings, the same or similar reference numerals may be used for the same or similar components.

FIG. 1 is a perspective view of a robotic vacuum cleaner according to an embodiment of the disclosure.

FIG. 2 is a bottom view of a robotic vacuum cleaner according to an embodiment of the disclosure.

FIG. 3 is a cross-sectional view taken along line A-A′ shown in FIG. 2.

FIG. 4A is a perspective view of a cleaning member according to an embodiment of the disclosure.

FIG. 4B is examples of reflective patterns of a cleaning member, in which a portion A shown in FIG. 4A is enlarged.

FIG. 5 is a control block diagram of a robotic vacuum cleaner according to an embodiment of the disclosure.

FIG. 6 is a control flowchart of a robotic vacuum cleaner according to an embodiment of the disclosure.

FIG. 7 is a graph representing a light reflection amount detected by an optical sensor according to an embodiment of the disclosure.

FIG. 8 is a flowchart illustrating a method of determining whether a cleaning member of a robotic vacuum cleaner is coupled, according to an embodiment of the disclosure.

FIG. 9 is a flowchart illustrating a method of determining whether a cleaning member of a robotic vacuum cleaner is coupled, according to an embodiment of the disclosure.

FIG. 10 is a flowchart illustrating a method of determining whether a cleaning member of a robotic vacuum cleaner is to be replaced, according to an embodiment of the disclosure.

FIG. 11 is a flowchart illustrating a method of detecting a failure of an optical sensor of a robotic vacuum cleaner, according to an embodiment of the disclosure.

### DETAILED DESCRIPTION

It should be appreciated that various example embodiments of the disclosure and the terms used therein are not intended to limit the technological features set forth herein to particular embodiments, and they may include various changes, equivalents, or replacements for a corresponding embodiment.

In connection with the description of drawings, like reference numerals may be used to refer to similar or related elements.

The singular form of a noun corresponding to an item may include one or more items, unless the relevant context explicitly indicates otherwise.

As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases.

As used herein, such terms as “1st” and “2nd,” or “first” and “second” may be used to simply distinguish a corresponding component from another, and does not limit the components in other aspect (e.g., importance or order).

It is to be understood that if an element (e.g., a first element) is referred to, with or without the term “operatively” or “communicatively”, as “coupled with”, “coupled to”, “connected with”, or “connected to” another element (e.g., a second element), it means that the element may be coupled with the other element directly (e.g., wired), wirelessly, or via a third element.

The terms “comprise”, “include” or “have” are intended to indicate that there are features, numbers, steps, operations, elements, parts, or a combination thereof described in the disclosure, and do not preclude the possibility of presence or addition of one or more other features, numbers, steps, operations, elements, parts, or a combination thereof.

When an element is referred to as being “connected”, “coupled”, “supported”, or “in contact” with (to) another element, it includes not only when the element is directly connected, coupled, supported, or in contact with the other element, but also when the element is indirectly connected, coupled, supported, or in contact with the other element via a third element.

When an element is referred to as being located “on” another element, it may include not only when the element is in contact with the other element, but also when another element exists between the two elements.

The term “and/or” includes any combination of a plurality of related elements or any one of a plurality of related elements.

Hereinafter, the operating principle and embodiments of the disclosure will be described with reference to the accompanying drawings.

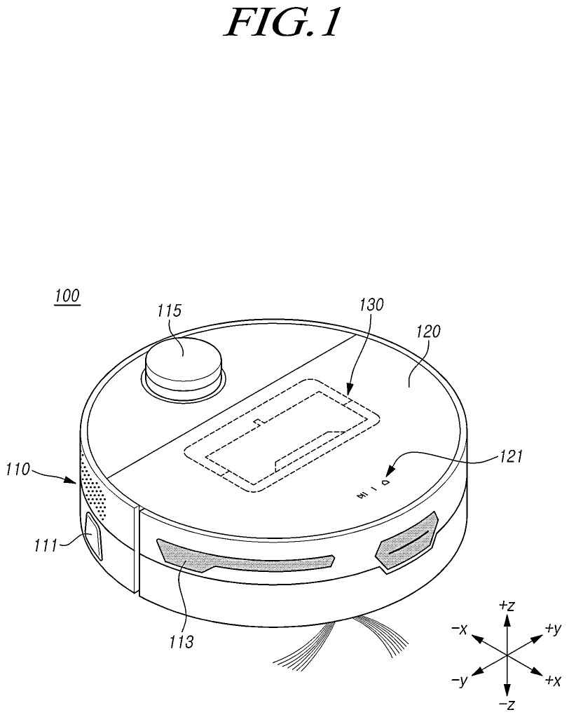

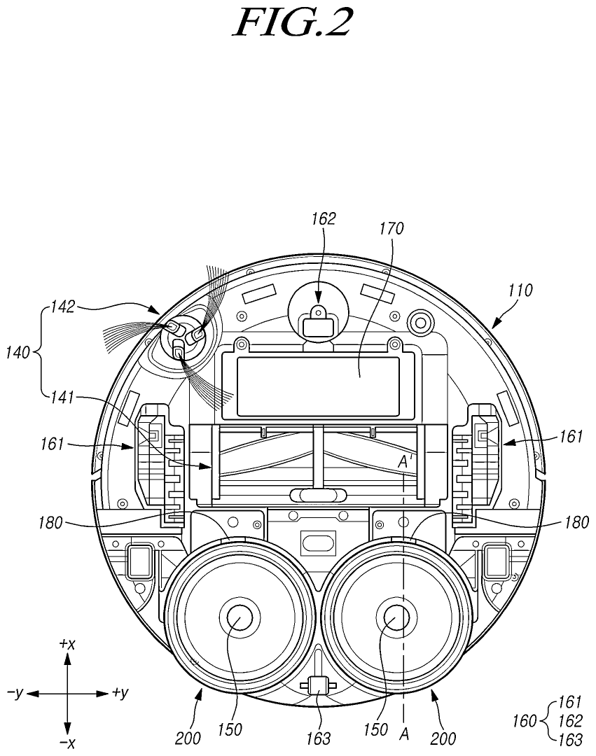

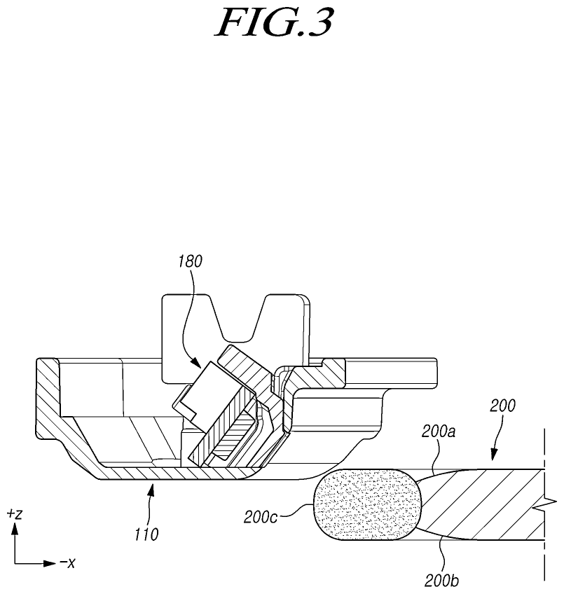

FIG. 1 is a perspective view of a robotic vacuum cleaner according to an embodiment of the disclosure. FIG. 2 is a bottom view of a robotic vacuum cleaner according to an embodiment of the disclosure. FIG. 3 is a cross-sectional view taken along line A-A′ shown in FIG. 2.

Referring to FIGS. 1 to 3, a robotic vacuum cleaner 100 may perform an operation to remove foreign substances (e.g., mopping) on a surface to be cleaned (e.g., a floor) by using a cleaning member 200 (e.g., a wet cloth or a dry cloth) detachably coupled to its lower part. For example, the robotic vacuum cleaner 100 may rotate the cleaning member 200, coupled to its lower part, after making a contact with the surface to be cleaned, and remove foreign substances (e.g., dust or dirt) from the surface to be cleaned by using a frictional force between the cleaning member 200 and the surface to be cleaned, generated by rotation of the cleaning member 200.

According to an example, the robotic vacuum cleaner 100 may include a main body 110, a body cover 120, a dust container 130, a brush part 140, a rotation part 150, a driving part 160, a battery 170, and an optical sensor 180.

According to an example, the main body 110 may form the overall appearance of the robotic vacuum cleaner 100.

In an example, a power switch 111 may be provided on a side of the main body 110. The power switch 111 may be disposed, for example, on a rear side of the main body 110, but the disclosure is not limited thereto. A user may turn on/off a power of the robotic vacuum cleaner 100 by manipulating the power switch 111.

In an example, an obstacle sensor 113 may be provided on a side of the main body 110. The obstacle sensor 113 may be also disposed, for example, on a front side of the main body 110, but the disclosure is not limited thereto. The obstacle sensor 113 may detect any obstacle in proximity to the robotic vacuum cleaner 100 when the robotic vacuum cleaner 100 is in operation (e.g., in motion). The robotic vacuum cleaner 100 may avoid obstacles by using the obstacle sensor 113 during operation. The obstacle sensor 113 may include, for example, at least one of an infrared ray sensor, an ultrasonic wave sensor, or a contact sensor.

In an example, a light detection and ranging (LiDAR) sensor 115 may be provided on a top side of the main body 110. The LiDAR sensor 115 may be located rearwardly of the top side of the main body 110. The LiDAR sensor 115 may emit light (e.g., a laser) to an outside and receive light reflected from an object (e.g., an external object) to obtain information such as a distance to the object, a positional direction, or a material. The LiDAR sensor 115 may obtain 360-degree geometric information about a driving area of the robotic vacuum cleaner. The robotic vacuum cleaner 100 may generate a map for the driving area based on the information obtained through the LiDAR sensor 115.

According to an example, the body cover 120 may be disposed on a top side of the main body 110. In an example, the body cover 120 may cover at least a portion of the top side of the main body 110. In an example, the body cover 120 may be rotatably connected to the main body 110. In this case, the user may rotate (or open) the body cover 120 to insert or extract the dust container 130 accommodated inside the main body 110.

In an example, a manipulation part 121 may be provided on the top side of the main cover 120. The manipulation part 121 may be configured to receive various instructions (e.g., start/stop cleaning, return home for charging, or change cleaning mode) related to the operation of the robotic vacuum cleaner 100 from the user. The manipulation part 121 may be implemented as, for example, an input module such as a button, a switch, or a touch panel.

According to an example, the dust container 130 may store foreign substances, such as dust, introduced into the robotic vacuum cleaner 100 according to the operation of the brush part 140. In an example, the dust container 130 may be disposed inside the main body 110 of the robotic vacuum cleaner 100 to be inserted into or extracted out of the main body 110.

According to an example, the brush part 140 may be disposed in a lower part of the robotic vacuum cleaner 100. In an example, when the robotic vacuum cleaner 100 is in operation, the brush part 140 may be configured to direct or guide foreign substances on the surface to be cleaned (e.g., sucked, swept, or mopped) toward the inside of the robotic vacuum cleaner 100 (e.g., into the dust container 130).

In an example, the brush part 140 may include a main brush 141 for introducing foreign substances on the surface to be cleaned into the robotic vacuum cleaner 100 upon driving of the robotic vacuum cleaner 100, and a sub brush 142 for moving foreign substances on the surface to be cleaned toward the main brush 141 upon driving of the robotic vacuum cleaner 100.

In an example, the main brush 141 may be positioned at or near the center area of the bottom side of the robotic vacuum cleaner 100. The main brush 141 may have a roller shape. The main brush 141 may rotate about a horizontal-axis direction (e.g., ±y-axis). In this case, when the robotic vacuum cleaner 100 is driven or in operation, foreign substances on the surface to be cleaned may be introduced into the dust container 130.

In an example, the sub brush 142 may be located near a front edge of the bottom side of the robotic vacuum cleaner 100. The sub brush 142 may include a plurality of brushes. A plurality of brushes may rotate about a vertical axis direction (e.g., ±z-axis direction). The sub brush 142 may move (or displace) foreign substances present at an edge of the robotic vacuum cleaner 100 to the main brush 141, while in rotation. In this case, when the robotic vacuum cleaner 100 is driven, any foreign substances near a wall or in a corner space of the driving area may be removed by the sub brush 142.

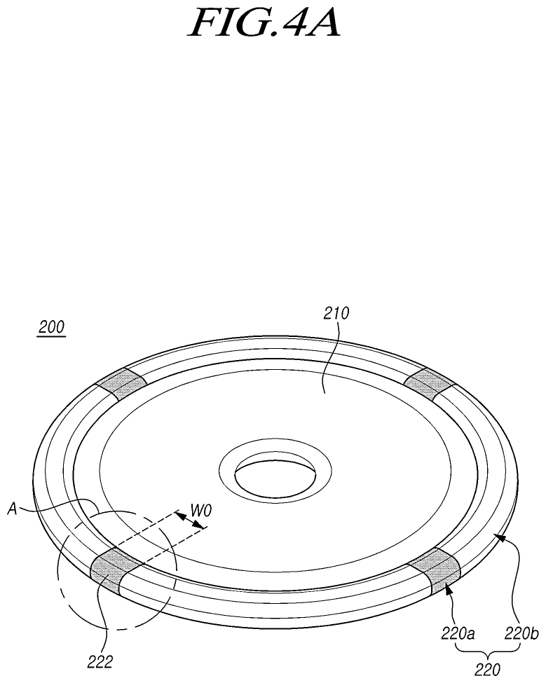

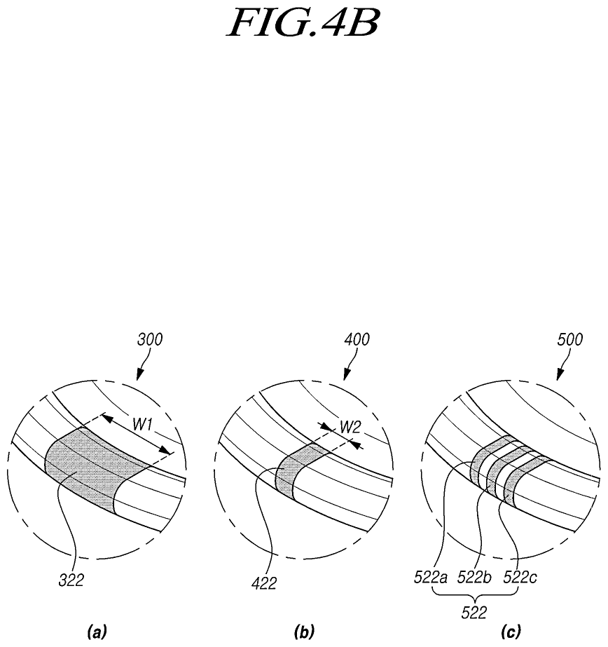

According to an example, the rotation part 150 may be disposed in a lower part of the robotic vacuum cleaner 100. The rotation part 150 may be located at a rear side of the bottom side of the robotic vacuum cleaner 100. The rotation part 150 may be provided in a pair, but the disclosure is not limited thereto. In an example, the cleaning member 200 may be detachably coupled to the rotation part 150. The cleaning member 200 may be detachably coupled to the rotation part 150 in a hook and loop manner (e.g., Velcro), but the disclosure is not limited thereto. For example, the cleaning member 200 may be detachably coupled to the rotation part 150 in a manner such as a hook or a screw. In an example, the cleaning member 200 may have a disk shape. In an example, the cleaning member 200 may include a first side (or upper surface) 200a facing the bottom side of the robot cleaner 100, a second side (or lower surface) 200b opposite to the first side 200a and facing the surface to be cleaned, or a third side (or surface of a side) 200c connecting the first side 200a and the second side 200b. At least one reflective pattern 222 may be provided on the surface of the cleaning member 200. The reflective pattern 222 may cause a pattern change in the light reflection amount detected by the optical sensor 180 when the rotation part 150 and the cleaning member 200 rotate. Hereinafter, the structure, shape, and/or material of the cleaning member 200 will be described later with reference to FIGS. 4A and 4B.

In an example, the rotation part 150 may rotate about a vertical axis direction (e.g., ±z-axis direction). If the cleaning member 200 is coupled to the rotation part 150, the cleaning member 200 may rotate with the rotation part 150 in contact with the surface to be cleaned during operation of the robotic vacuum cleaner 100. In this case, foreign substances (e.g., stains) on the surface to be cleaned may be removed by the frictional force between the cleaning member 200 and the surface to be cleaned.

According to an example, the driving part 160 may be disposed at a lower part of the robotic vacuum cleaner 100. The driving part 160 may support the robotic vacuum cleaner 100 to drive forward, backward, or other directions.

In an example, the driving part 160 may include a pair of main wheels 161 and auxiliary rollers (162 and 163) respectively disposed at the front/rear sides of the pair of main wheels 161. The pair of main wheels 161 may rotate by receiving the power from a driver (not shown) (e.g., a motor) provided inside the robotic vacuum cleaner 100. The auxiliary rollers (162 and 163) may assist driving the robotic vacuum cleaner 100 in front/rear of the pair of main wheels 161.

According to an example, the battery 170 may be disposed inside the main body 110 of the robotic vacuum cleaner 100. In an example, the battery 170 may be provided to be detachable from or attached to the underside of the main body 110 for replacement. In an example, the battery 170 may supply power to the brush part 140, the rotation part 150, and/or the driving part 160. The battery 170 may be charged by receiving power from a docking station in a wired or wireless manner while the robotic vacuum cleaner 100 is stationed or positioned at the docking station (not shown).

According to an example, the optical sensor 180 may emit light toward the cleaning member 200 coupled to the rotation part 150 and measure the amount of light reflected from the cleaning member 200. In an example, the optical sensor 180 may include a light emitting part provided with a light source for radiating light, a light receiving part for receiving the light reflected from an object such as the cleaning member 200, and a printed circuit board (PCB) on which the light emitting part and the light receiving part are disposed.

In an example, the optical sensor 180 may be disposed inside the main body 110 of the robotic vacuum cleaner 100. The optical sensor 180 may be disposed at a position close to the rotation part 150 and/or the cleaning member 200. In an example, the optical sensor 180 may be positioned above the cleaning member 200 coupled to the rotation part 150 in the circumferential direction (e.g., +z-axis direction). The optical sensor 180 may be disposed to face (or oppose) at least a portion of the reflective pattern 222 of the cleaning member 200, when the rotation part 150 and the cleaning member 200 rotate.

FIG. 4A is a perspective view of a cleaning member according to an embodiment of the disclosure.

Referring to FIG. 4A, in an example, the cleaning member 200 may include a body portion 210 and a rim portion 220 surrounding the body portion 210. In an example, the body portion 210 may form the overall external appearance of the cleaning member 200. In an example, the rim portion 220 may extend along a circumference of the body portion 210 and may form an edge of the cleaning member 200.

According to an example, at least one reflective pattern 222 may be provided on a surface of the cleaning member 200. At least one reflective pattern 222 may be provided, for example, on the top surface (eg, 200a of FIG. 3) and/or the side (eg, 200c of FIG. 3) of the cleaning member 200.

In an example, at least one reflective pattern 222 may be disposed on the rim portion 220. For example, the reflective pattern 222 may extend along the upper side and the side of the rim portion 220. The reflective pattern 222 may have a belt shape. However, the shape of the reflective pattern 222 is not limited thereto, and the reflective pattern 222 may be implemented in various shapes such as a circle, a triangle, or a polygon.

In an example, at least one reflective pattern 222 may be disposed on an upper side of the body portion 210 or the rim portion 220. In this case, the optical sensor 180 may be disposed on an underside of the main body 110 of the robotic vacuum cleaner 100 to face (or oppose) the reflective pattern 222 on the upper side of the rim portion 220.

According to an example, the rim portion 220 may include a first region 220a in which the reflective pattern 222 is provided and a second region 220b in which the reflective pattern 222 is not provided. The first region 220a and the second region 220b may be alternately disposed on the rim portion 220 along the circumferential direction of the cleaning member 200.

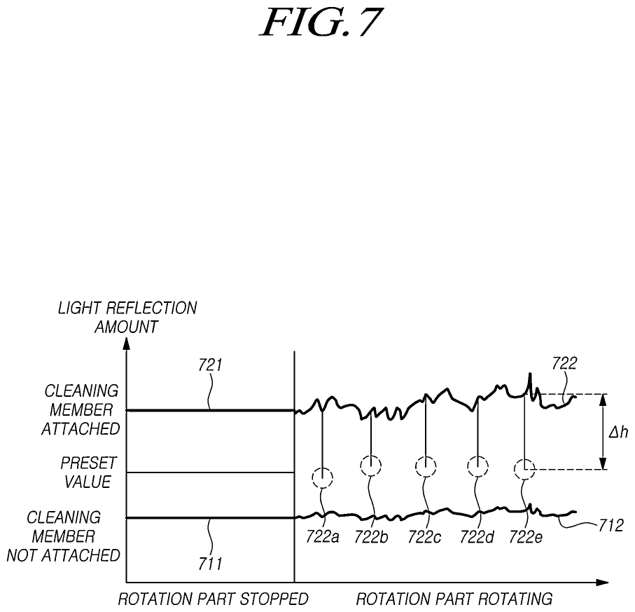

According to an example, the first region 220a and the second region 220b may have a color having a different light reflectance (or light absorption rate). For example, the reflective pattern 222 and the second region 220b may have a color having a different light reflectance (or light absorption rate). In an example, the reflective pattern 222 may have a color having a lower light reflectance than that of the second region 220b. For example, the reflective pattern 222 may have a color (e.g., black) having a relatively lower light reflectance, and the second region 220b may have a color (e.g., white) having a higher light reflectance than the reflective pattern 222. In this case, when the cleaning member 200 rotates, pattern changes (722a, 722b, 722c, 722d, 722e) may occur due to the reflective pattern 222, as illustrated in a graph of FIG. 7. In some examples, the reflective pattern 222 may have a color having a higher light reflectance than the second region 220b.

According to an example, the first region 220a, for example, the reflective pattern 222 and the second region 220b may be formed of a material having a different light reflectance (or light absorption rate). In an example, the reflective pattern 222 may be made of a material having a lower light reflectance than the second region 220b. In some examples, the reflective pattern 222 may be made of a material having a higher light reflectance than the second region 220b. For example, the reflective pattern 222 may be made of a metal material having a relatively high light reflectance, and the second region 220b may be made of a cloth material having a lower light reflectance than the reflective pattern 222.

If at least one reflective pattern 222 is provided on the surface of the cleaning member 200 as described above, the pattern of values of the light reflection amount detected by the optical sensor 180 may change while the cleaning member 200 rotates, and the robotic vacuum cleaner 100 may detect the pattern of the light reflection amount to determine a coupling state of the cleaning member 200 and/or whether to replace the same.

FIG. 4B is examples of reflective patterns of a cleaning member, in which a portion A shown in FIG. 4A is enlarged. (a) to (c) of FIG. 4B illustrate various shapes of reflective patterns (322, 422, 522) of the cleaning members (300, 400, 500).

The structures of the cleaning members (300, 400, 500) illustrated in (a), (b) and (c) of FIG. 4B are substantially the same as those of the cleaning member 200 of FIG. 4A, and thus description will be made focusing the different reflective patterns (322, 422, 522).

Referring to (a) of FIG. 4B, the reflective pattern 322 of the cleaning member 300 according to an embodiment may be provided to have a larger width W1 than the width W0 of the reflective pattern 222 of FIG. 4A. In this case, widths of the pattern changes (722a, 722b, 722c, 722d) of the light reflection amount illustrated in the graph of FIG. 7 (will be described later) may be generated to be wider.

Referring to (b) of FIG. 4B, the reflective pattern 422 of the cleaning member 400 according to an embodiment may be provided to have a smaller width W2 than the width W0 of the reflective pattern 222 of FIG. 4A. In this case, widths of the pattern changes (722a, 722b, 722c, 722d) of the light reflection amount illustrated in the graph of FIG. 7 (will be described later) may be generated to be narrower.

Referring to (c) of FIG. 4B, the reflective pattern 522 of the cleaning member 500 according to an embodiment may include a plurality of segments (522a, 522b, 522c) spaced apart from each other at predetermined intervals along the circumferential direction of the cleaning member 500. In this case, a frequency of occurrence of the pattern changes (722a, 722b, 722c, 722d) in the light reflection amount illustrated in the graph of FIG. 7 (will be described later) may increase in proportion to the number of the plurality of segments (522a, 522b, 522c).

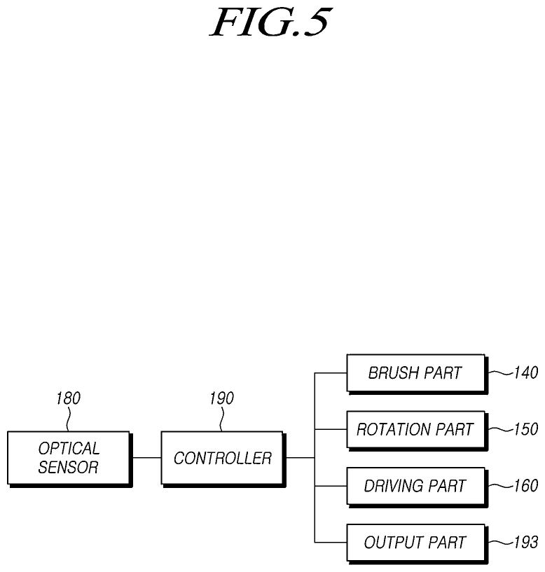

FIG. 5 is a control block diagram of a robotic vacuum cleaner according to an embodiment of the disclosure.

Referring to FIG. 5, the robotic vacuum cleaner 100 according to an embodiment may include a controller 190 configured to control the overall operation of the robotic vacuum cleaner 100.

According to an example, the controller 190 may be configured to control operations of a brush part 140, a rotation part 150, a driving part 160, or an output part 193.

In an example, the controller 190 may be configured to control the brush part 140 to adjust a rotational speed or a rotational direction of the main brush 141 and the sub brush 142. In this case, the robotic vacuum cleaner 100 may be changed to a dry-cleaning mode in response to the adjusted rotational speed or rotational direction of the brushes 141 and 142.

In an example, the controller 190 may be configured to control the rotation part 150 to adjust a rotational speed or a rotational direction of the rotation part 150 or the cleaning member 200 coupled to the rotation part 150. In this case, the robotic vacuum cleaner 100 may be changed to a wet-cleaning mode in response to the adjusted rotational speed or rotational direction of the rotation part 150 or the cleaning member 200.

In an example, the controller 190 may be configured to control the driving part (not shown) to control movement of the driving part 160. For example, the controller 190 may control the movement of the driving part 160 to adjust a driving speed or a driving direction of the robotic vacuum cleaner 100.

In an example, the controller 190 may be configured to receive, from the optical sensor 180, data related to light reflected from the cleaning member 200, such as the light reflection amount.

In an example, the controller 190 may be configured to detect a pattern change in the light reflection amount caused by the reflective pattern 222 of the cleaning member 200, based on the data regarding the light reflection amount received from the optical sensor 180. In an example, the controller 190 may be configured to determine the coupling state of the cleaning member 200 and/or whether to replace the cleaning member 200, based on the pattern change in the light reflection amount.

According to an example of the disclosure, the robotic vacuum cleaner 100 may include an output part 193 to output information about an operation of the robotic vacuum cleaner 100 and/or a state of the cleaning member 200.

In an example, the output part 193 may include a display that outputs information about the operation of the robotic vacuum cleaner 100 and/or the state of the cleaning member 200 in the form of text or an image. In an example, the output part 193 may include a speaker that outputs information about the operation of the robotic vacuum cleaner 100 and/or the state of the cleaning member 200 in form of a voice.

According to an example, the controller 190 may be configured to control the output part 193 to provide the user with information about the operation of the robotic vacuum cleaner 100 and/or the state of the cleaning member 200.

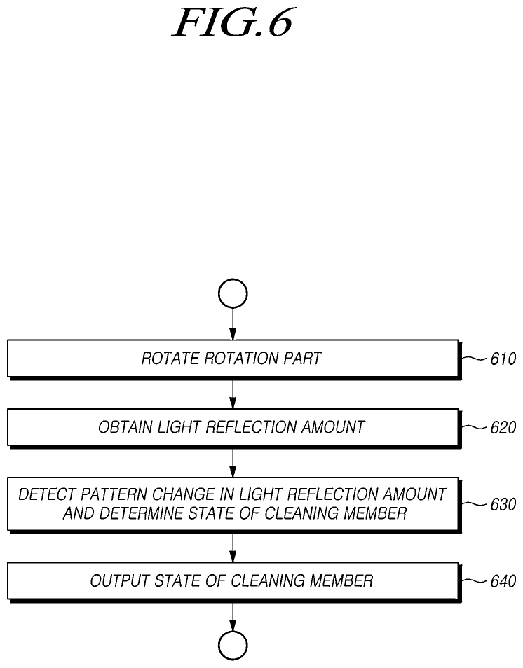

FIG. 6 is a control flowchart of a robotic vacuum cleaner according to an embodiment of the disclosure.

FIG. 6 is a flowchart illustrating an example method for determining a coupling state of the cleaning member 200.

Referring to FIG. 6, in operation 610, the robotic vacuum cleaner 100 according to an embodiment may be configured to control the rotation part 150 to rotate the rotation part 150 and/or the cleaning member 200 coupled to the rotation part 150.

According to an example, in operation 620, the robotic vacuum cleaner 100 may obtain the light reflection amount reflected from the cleaning member 200 by the optical sensor 180, when the rotation part 150 and/or the cleaning member 200 coupled to the rotation part 150 rotates.

According to an example, in operation 630, the robotic vacuum cleaner 100 may detect a pattern change in the light reflection amount caused by the reflective pattern 222 of the cleaning member 200 in the obtained light reflection amount and may determine the state of the cleaning member 200 based on the detected pattern change in the light reflection amount. For example, the state of the cleaning member 200 may include the coupling state of the cleaning member 200 or whether to replace the cleaning member 200 (or a degree of wear and tear).

According to an example, in operation 640, the robotic vacuum cleaner 100 may provide the user with the determined state of the cleaning member 200, using the output part 193.

FIG. 7 is a graph illustrating a light reflection amount detected by an optical sensor according to an embodiment of the disclosure.

FIG. 7 illustrates an example graph related to the light reflection amount obtained from the optical sensor 180 when the cleaning member 200 is stationary (or fixed) and rotating with the cleaning member 200 coupled to the rotation part 150 of the robotic vacuum cleaner 100, and an example graph related to the light reflection amount obtained from the optical sensor 180 when the cleaning member 200 is stationary (or fixed) and rotating with the cleaning member 200 not coupled to the rotation part 150 of the robotic vacuum cleaner 100.

Referring to FIG. 7, with respect to the light reflection amount measured by the optical sensor 180 while the rotation part 150 is stationary, the light reflection amount 721 is greater if the cleaning member 200 being coupled to the rotation part 150 than the light reflection amount 711 if the cleaning member 200 being not coupled to the rotation part 150. Further, each of the light reflection amounts 711 and 721 measured in the two cases maintains a constant value.

In this case, if the light reflection amount measured by the optical sensor 180 is greater than a predetermined reference value, the robotic vacuum cleaner 100 may determine that the cleaning member 200 is coupled to the rotation part 150.

However, when noise having a value higher than the preset value is measured being generated by various environmental factors, such as a change in materials of the surface to be cleaned, the robotic vacuum cleaner 100 may incorrectly determine that the cleaning member 200 is normally coupled to the rotation part 150 even if the cleaning member 200 is not actually properly coupled to the rotation part 150.

With respect to the light reflection amount 712 measured by the optical sensor 180 during the rotation of the rotation part 150 without the cleaning member 200 coupled to the rotation part 150, the light reflection amount fluctuates slightly due to rotation of the rotation part 150.

With respect to the light reflection amount 722 measured by the optical sensor 180 during the rotation of the rotation part 150 with the cleaning member 200 coupled to the rotation part 150, that the values of the light reflection amount 722a, 722b, 722c and 722d having a sharp change in width Δh from a neighboring light reflection amount are measured, as the pattern change in the light reflection amount is caused by the reflective pattern 222 of the cleaning member 200 having a different light reflectance.

In such a circumstance, the robotic vacuum cleaner 100 may determine whether the cleaning member 200 is coupled or not, based on the pattern change in the light reflection amount rather than a fixed preset value, thereby improving the accuracy and reliability of determining whether the cleaning member 200 is correctly mounted thereon.

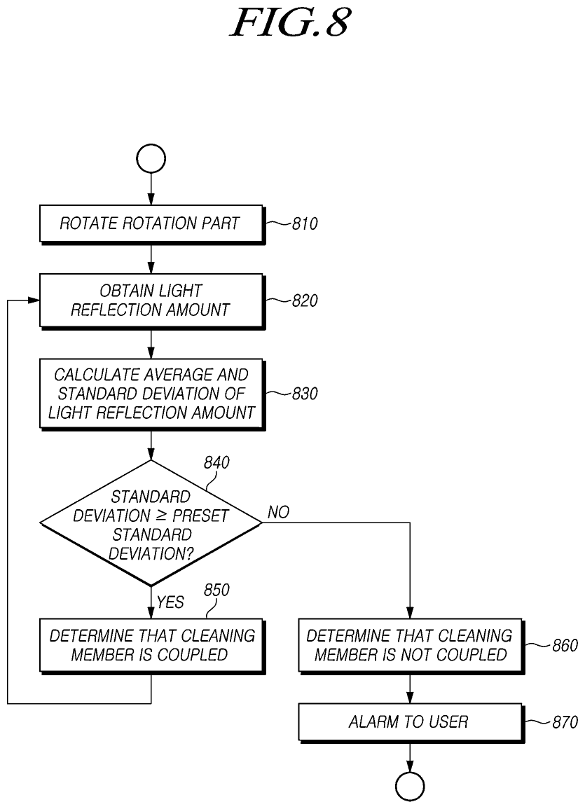

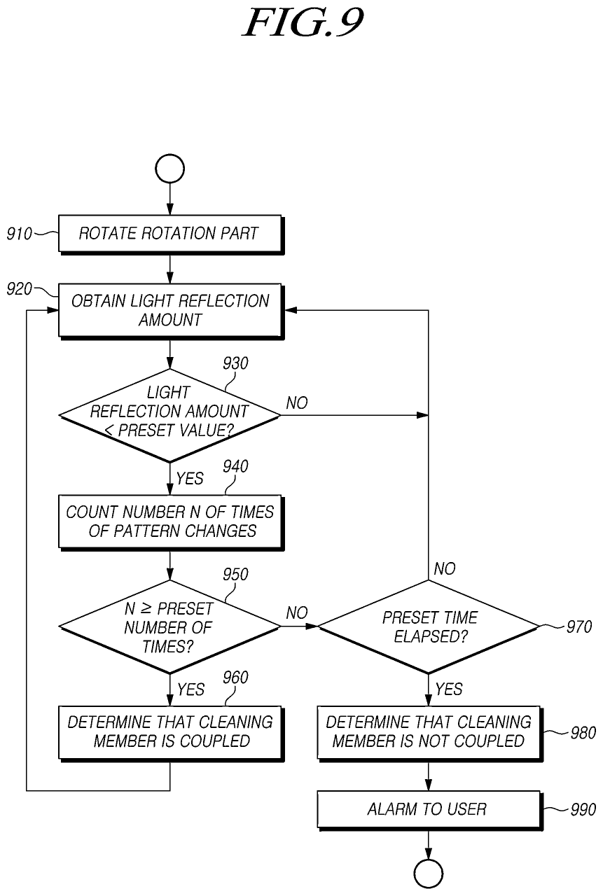

Hereinafter, referring to FIGS. 8 and 9, a specific method of determining whether the cleaning member 200 is mounted or not, based on the pattern change in the light reflection amount, will be described.

FIG. 8 is a flowchart illustrating an example of a method of determining whether a cleaning member is coupled to a robotic vacuum cleaner according to an embodiment of the disclosure.

Referring to FIG. 8, the robotic vacuum cleaner 100 according to an embodiment may detect a pattern change (e.g., 722a, 722b, 722c, 722d, or 722e of FIG. 7) in the light reflection amount caused by the reflective pattern 222 of the cleaning member 200 from the light reflection amount obtained from the optical sensor 180. The robotic vacuum cleaner 100 may then determine whether the cleaning member 200 is coupled to the rotation part 150, using an average value and a standard deviation of the light reflection amount for a predetermined time that varies according to the pattern change in the light reflection amount.

According to an example, in operation 810, the robotic vacuum cleaner 100 may rotate the rotation part 150.

According to an example, in operation 820, the robotic vacuum cleaner 100 may obtain the amount of light reflected from an object such as the cleaning member 200 for a predetermined time through the optical sensor 180, such as the light reflection amount.

According to an example, in operation 830, the robotic vacuum cleaner 100 may calculate an average value and a standard deviation of the light reflection amount based on the obtained light reflection amount for a predetermined time.

According to an example, in operation 840, the robotic vacuum cleaner 100 may determine whether the calculated standard deviation is greater than or equal to a preset standard deviation.

According to an example, if the calculated standard deviation is equal to or greater than the preset standard deviation (in case of “Yes” in operation 840), the robotic vacuum cleaner 100 may determine that the cleaning member 200 is coupled to the rotation part 150 in operation 850. Thereafter, the robotic vacuum cleaner 100 may repeat the operation 820 and its subsequent operations.

According to an example, if the calculated standard deviation is less than the preset standard deviation (in case of “No” in operation 840), the robotic vacuum cleaner 100 may determine that the cleaning member 200 is not coupled to the rotation part 150 in operation 860.

According to an example, the robotic vacuum cleaner 100 may provide the user with a coupling state of the cleaning member 200 via the output part 193. In an example, following operation 860, the robotic vacuum cleaner 100 may provide the user with information about the state in which the cleaning member 200 is not coupled to the rotation part 150 via the output part 193 in operation 870.

FIG. 9 is a flowchart illustrating an example of a method of determining whether a cleaning member is coupled to a robotic vacuum cleaner according to an embodiment of the disclosure.

Referring to FIG. 9, the robotic vacuum cleaner 100 according to an embodiment may detect a pattern change (e.g., 722a, 722b, 722c, 722d, or 722e of FIG. 7) in the light reflection amount caused by the reflective pattern 222 of the cleaning member 200 from the light reflection amount obtained from the optical sensor 180. The robotic vacuum cleaner 100 may then count the number of pattern changes in the light reflection amount to determine whether the cleaning member 200 is coupled to the rotation part 150.

According to an example, in operation 910, the robotic vacuum cleaner 100 may rotate the rotation part 150.

According to an example, in operation 920, the robotic vacuum cleaner 100 may obtain the amount of light reflected from an object such as the cleaning member 200, such as the light reflection amount, through the optical sensor 180.

According to an example, in operation 930, the robotic vacuum cleaner 100 may detect a pattern change (e.g., 722a, 722b, 722c, 722d, or 722e of FIG. 7) of the light reflection amount by comparing the light reflection amount obtained from the optical sensor 180 with a preset light reflection amount. For example, if the light reflection amount obtained from the optical sensor 180 is less than the preset light reflection amount, the robotic vacuum cleaner 100 may determine that the pattern change in the light reflection amount has occurred due to the reflective pattern 222 of the cleaning member 200.

According to an example, if the pattern change in the light reflection amount is detected (in case of “Yes” in 930), the robotic vacuum cleaner 100 may count the number n times of detecting the pattern change in the light reflection amount in operation 940.

According to an example, in operation 950, the robotic vacuum cleaner 100 may compare the number n times of detecting the pattern change in the light reflection amount with a preset number of times.

According to an example, if the number n times of detecting the pattern change in the light reflection amount is greater than or equal to the preset number of times (in case of “Yes” in operation 950), the robotic vacuum cleaner 100 may determine that the cleaning member 200 is coupled to the rotation part 150 in operation 960. Thereafter, the robotic vacuum cleaner 100 may repeat the operation 920 and its subsequent operations.

According to an example, if the number n times of detecting the pattern change in the light reflection amount is less than the preset number of times (in case of “no” in operation 950), the robotic vacuum cleaner 100 may determine whether a measurement time of the light reflection amount has elapsed a preset time in operation 970.

According to an example, if the measurement time of the light reflection amount does not elapse the preset time (in case of “No” in operation 970), the robotic vacuum cleaner 100 may proceed to the operation 920 to repeat the operation 920 and its subsequent operations.

According to an example, if the measurement time of the light reflection amount has elapsed the preset time (in case of “Yes” in operation 970), the robotic vacuum cleaner 100 may determine that the cleaning member 200 has not been coupled to the rotation part 150 in operation 980.

According to an example, the robotic vacuum cleaner 100 may provide the user with the coupling state of the cleaning member 200 via the output part 193. In an example, after performing the operation 980, in operation 990, the robotic vacuum cleaner 100 may provide the user with information about the state in which the cleaning member 200 has not been coupled to the rotation part 150, via the output part 193.

The method of determining whether the cleaning member 200 described above with reference to FIGS. 8 and 9 is coupled to the rotation part 150 may be also applied in substantially the same manner to a method of determining whether the cleaning member 200 is coupled to a correct position of the rotation part 150. In an example, during rotation of the rotation part 150 and the cleaning member 200, the robotic vacuum cleaner 100 may determine whether the cleaning member 200 is eccentrically coupled from a correct position of the rotation part 150 in consideration of whether values of the light reflection amount obtained from the optical sensor 180 form a shape of a periodic function (e.g., a sine wave). In an example, during rotation of the rotation part 150 and the cleaning member 200, the robotic vacuum cleaner 100 may determine whether the cleaning member 200 is eccentrically coupled from the correct position of the rotation part 150 in consideration of whether the pattern change in the light reflection amount by the reflective pattern 222 of the cleaning member 200 is detected in the values of the light reflection amount obtained from the optical sensor 180.

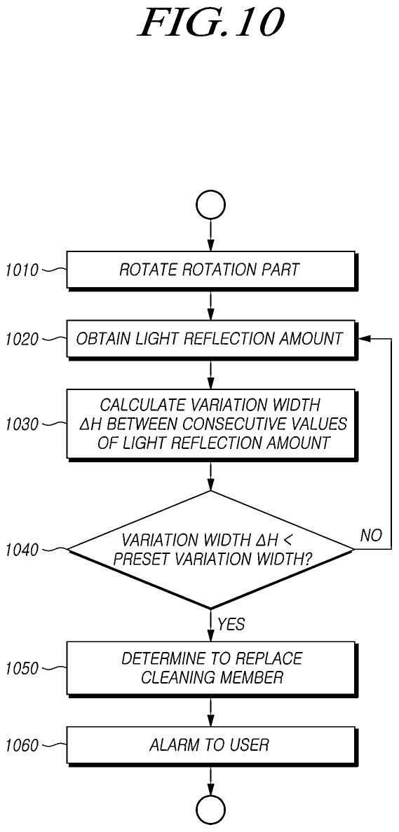

FIG. 10 is a flowchart illustrating an example of a method of determining whether to replace a cleaning member of a robotic vacuum cleaner according to an embodiment of the disclosure.

Referring to FIG. 10, the robotic vacuum cleaner 100 according to an embodiment may be configured to detect a pattern change (e.g., 722a, 722b, 722c, 722d, or 722e of FIG. 7) in the light reflection amount caused by the reflective pattern 222 of the cleaning member 200 from the light reflection amount obtained from the optical sensor 180. Further, the robotic vacuum cleaner 100 may then determine whether to replace the cleaning member 200 coupled to the rotation part 150 (or a degree of wear), using a width Δh (see FIG. 7) of the pattern change in the detected light reflection amount.

According to an example, in operation 1010, the robotic vacuum cleaner 100 may rotate the rotation part 150.

According to an example, in operation 1020, the robotic vacuum cleaner 100 may be configured to obtain the amount of light reflected from an object such as the cleaning member 200 through the optical sensor 180, such as the light reflection amount.

According to an example, in operation 1030, the robotic vacuum cleaner 100 may be configured to calculate a variation width (or deviation) Δh between consecutive values of the light reflection amount among the values of the light reflection amount obtained from the optical sensor 180.

According to an example, in operation 1040, the robotic vacuum cleaner 100 may be configured to compare the variation width Δh between the calculated values of the light reflection amount with a preset variation width. The preset variation width may correspond to a variation width between consecutive values of the light reflection amount calculated while an unused cleaning member 200 rotates.

According to an example, if the variation width Δh of the calculated light reflection value is greater than the preset variation width (in case of “No” in operation 1040), the robotic vacuum cleaner 100 may proceed to the operation 1020 to repeat the operation 1020 and its subsequent operations.

According to an example, if the variation width Δh of the calculated light reflection value is smaller than the preset variation width (in case of “Yes” in operation 1040), the robotic vacuum cleaner 100 may determine that the reflective pattern 222 of the cleaning member 200 is worn out and the cleaning member 200 needs to be replaced in operation 1050.

According to an example, after performing the operation 1050, in operation 1060, the robotic vacuum cleaner 100 may provide the user with information (or an alarm) regarding replacement of the cleaning member 200 via the output part 193.

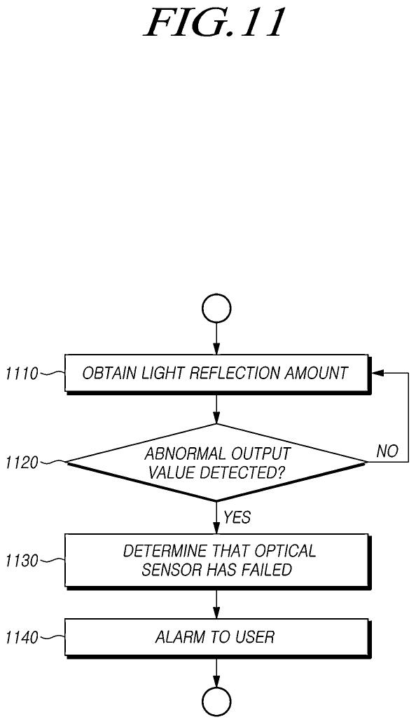

FIG. 11 is a flowchart illustrating an example of a method of detecting a failure of an optical sensor of a robotic vacuum cleaner according to an embodiment of the disclosure.

Referring to FIG. 11, in operation 1110, the robotic vacuum cleaner 100 according to an embodiment may obtain the amount of light reflected from an object, such as the cleaning member 200, through the optical sensor 180, such as the light reflection amount.

According to an example, in operation 1120, the robotic vacuum cleaner 100 may be configured to determine whether an abnormal output value is detected based on the values of the light reflection amount obtained from the optical sensor 180. In an example, if the value of the light reflection amount obtained from the optical sensor 180 is greater than or equal to a preset upper limit value, the robotic vacuum cleaner 100 may determine the value of the light reflection amount as an abnormal output value. In an example, if the value of the light reflection amount obtained from the optical sensor 180 is less than or equal to a preset lower limit value (e.g., zero), the robotic vacuum cleaner 100 may determine the value of the light reflection amount as an abnormal output value. That is, the robotic vacuum cleaner 100 may determine the value of the light reflection amount within a range between the upper limit value and the lower limit value as the normal output value.

According to an example, in operation 1130, if the abnormal output value is detected (in case of “Yes” in operation 1120), the robotic vacuum cleaner 100 may be configured to determine that a failure of the optical sensor 180 has occurred.

According to an example, in operation 1140, the robotic vacuum cleaner 100 may be configured to provide the user with information about the failure state of the optical sensor 180 via the output part 193.

The method of determining a failure of the optical sensor 180, as described above, may be applied in substantially the same manner in case where any error occurs in the optical sensor 180 due to contamination of the cleaning member 200. For example, the robotic vacuum cleaner 100 may be configured to determine whether an error occurs in the optical sensor 180 due to contamination of the cleaning member 200 based on whether an abnormal output value is detected through the optical sensor 180.

A robotic vacuum cleaner 100 according to an embodiment of the disclosure may include a main body 110 forming an outer appearance of the robotic vacuum cleaner 100, a rotation part 150 rotatably disposed on a lower side of the main body 110, a cleaning member 200, 300, 400, 500 detachably couplable to the rotation part 150 and having at least one reflective pattern 222, 322, 422, 522 provided on a surface thereof, and an optical sensor 180 disposed at a position close to the rotation part 150, emitting light toward the cleaning member 200, 300, 400, 500, and obtaining a light reflection amount reflected by the cleaning member 200, 300, 400, 500. The at least one reflective pattern 222, 322, 422, 522 may have a different reflectance from a remaining region 220b of the surface not provided with the reflective pattern 222, 322, 422, 522.

According to an example, the optical sensor 180 may be disposed on a lower part of the main body 110 and may be positioned above the cleaning member 200.

According to an example, the optical sensor 180 may be disposed on a bottom side of the main body 110 and may face toward the surface.

According to an example, the at least one reflective pattern 222 may be formed on an edge of an upper side of the cleaning member 200.

According to an example, the at least one reflective pattern 222 may be extended from an upper side to a side of the cleaning member 200.

According to an example, each of the at least one reflective pattern 522 may include a plurality of segments 522a, 522b, 522c spaced apart from each other.

According to an example, the at least one reflective pattern 222 may have a higher reflectance than that of the remaining region 220b of the surface.

According to an example, the at least one reflective pattern 222 may have a lower reflectance than that of the remaining region 220b of the surface.

According to an example, the robotic vacuum cleaner 100 may include a controller 190 configured to control rotation of the rotation part 150, receive data about the light reflection amount from the optical sensor 180 when the rotation part 150 rotates, detect a pattern change in the light reflection amount from the received data, and determine the state of the cleaning member 200, 300, 400, 500 based on the detected pattern change.

According to an example, the controller 190 may be configured to calculate an average and a standard deviation of values of the received light reflection amount over a predetermined time, compare the calculated standard deviation with a preset standard deviation, and determine that the cleaning member 200, 300, 400, 500 is detached from the rotation part 150 if the calculated standard deviation is less than the preset standard deviation.

According to an example, the controller 190 may be configured to compare values of the light reflection amount received from the optical sensor 180, count a number of times a value of the received light reflection amount is less than or equal to the preset value, compare, after a lapse of the predetermined time, is less than a preset number of times, and determine that the cleaning member 200 is detached from the rotation part 150 when the counted number of times is less than the preset number of times.

According to an example, the robotic vacuum cleaner 100 may further include an output part 193 configured to provide information about a state of the cleaning member 200 to a user. The controller 190 may be configured to output, via the output part 193, information about the detachment of the cleaning member 200, 300, 400, 500 from the rotation part 150 if the controller 190 determines that the cleaning member 200, 300, 400, 500 is detached from the rotation part 150.

According to an example, the controller 190 may be configured to receive the light reflection amount from the optical sensor 180, calculate a variation width Δh between consecutive values of the received light reflection amount, compare the calculated variation width Δh with a preset variation width Δh, and determine, based on the comparison, that a time for replacement of the cleaning member 200, 300, 400, 500 is reached if the variation width is less than the preset variation width Δh.

According to an example, the robotic vacuum cleaner 100 may further include an output part 193 configured to provide information about the time for replacement to a user. The controller 190 may configured to output, via the output part 193, information about the time for replacement if the controller 190 determines that the time for replacement is reached.

According to an example, a method for controlling a robotic vacuum cleaner 100 according to an embodiment of the disclosure may include rotating a rotation part 150 of the robotic vacuum cleaner 100, emitting light to a cleaning member 200 provided with a reflective pattern 222 through an optical sensor 180 and detecting an amount of light reflected from the cleaning member 200 through an optical sensor 180 and detecting a pattern change in the detected light reflection amount by the optical sensor 180, and determining a state of the cleaning member 200, 300, 400, 500 based on the detected pattern change.

According to an example, the method for controlling a robotic vacuum cleaner 100 may further include calculating an average and a standard deviation of values of the light reflection amount measured by the optical sensor 180 over a predetermined time, comparing the calculated standard deviation with a preset standard deviation, and determining the state of the cleaning member 200, 300, 400, 500 based on a result of the comparison.

According to an example, the method for controlling a robotic vacuum cleaner 100 may include counting, for a predetermined time, a number of times a value of light reflection amount received by the optical sensor 180 is less than a preset value, comparing the counted number of times to a preset number of times, and determining the state of the cleaning member 200, 300, 400, 500 based on a result of the comparison.

According to an example, the method for controlling a robotic vacuum cleaner 100 may include calculating a variation width Δh between consecutive values of light reflection amount by the optical sensor 180, and determining a time for replacement of the cleaning member by comparing the calculated variation width with a preset variation width.

According to an example, the method of controlling the robotic vacuum cleaner 100 may further include providing information about the state of the cleaning member 200, 300, 400, 500 to a user via the output part 193.

A cleaning member 200 detachably coupled to a robotic vacuum cleaner 100 according to an embodiment of the disclosure may include a main body 210, 220 including a surface having a first reflectance, and a reflective pattern 222 on the surface of the main body 210, 220 and having a second reflectance different from the reflectance.

What is claimed is:

1. A robotic vacuum cleaner comprising:
a main body forming an outer appearance;
a rotation part rotatably disposed on a lower side of the main body;
a cleaning member detachably couplable to the rotation part and having at least one reflective pattern provided on a surface thereof; and
an optical sensor disposed at a position adjacent to the rotation part, emitting light toward the cleaning member and obtaining a light reflection amount reflected by the cleaning member, and
wherein the at least one reflective pattern has a different reflectance from a remaining region of the surface not provided with the at least one reflective pattern.

2. The robotic vacuum cleaner of claim 1, wherein the optical sensor is disposed on a lower part of the main body and is positioned above the cleaning member.

3. The robotic vacuum cleaner of claim 1, wherein the optical sensor is disposed on a bottom side of the main body and faces toward the surface.

4. The robotic vacuum cleaner of claim 1, wherein the at least one reflective pattern is formed on an edge of an upper side of the cleaning member.

5. The robotic vacuum cleaner of claim 1, wherein the at least one reflective pattern is extended from a top side to a side of the cleaning member.

6. The robotic vacuum cleaner of claim 1, wherein each of the at least one reflective pattern includes a plurality of segments spaced apart from each other.

7. The robotic vacuum cleaner of claim 1, wherein the at least one reflective pattern has a higher reflectance than the remaining region of the surface.

8. The robotic vacuum cleaner of claim 1, wherein the at least one reflective pattern has a lower reflectance than the remaining region of the surface.

9. The robotic vacuum cleaner of claim 1, further comprising:
a controller configured to:
control rotation of the rotation part,
receive data about the light reflection amount from the optical sensor when the rotation part 150 rotates,
detect a pattern change in the light reflection amount from the received data, and
determine the state of the cleaning member based on the detected pattern change.

10. The robotic vacuum cleaner of claim 9,
wherein the controller is configured to:
calculate an average and a standard deviation of values of the received light reflection amount over a predetermined time, and
compare the calculated standard deviation with a preset standard deviation, and
determine that the cleaning member is detached from the rotation part if the calculated standard deviation is less than the preset standard deviation.

11. The robotic vacuum cleaner of claim 9,
wherein the controller is configured to:
compare values of the light reflection amount received from the optical sensor,
count a number of times a value of the received light reflection amount is less than or equal to a preset value,
compare, after a lapse of the predetermined time, the counted number of times with a preset number of times, and
determine that the cleaning member is detached from the rotation part when the counted number of times is less than the preset number of times.

12. The robotic vacuum cleaner of claim 10, further comprising:
an output part configured to provide information about the state of the cleaning member to a user,
wherein the controller is configured to output, via the output part, information about detachment of the cleaning member from the rotation part if the controller determines that the cleaning member is detached from the rotation part.

13. The robotic vacuum cleaner of claim 9,
wherein the controller is configured to:
receive the light reflection amount from the optical sensor,
calculate a variation width between consecutive values of the received light reflection amount,
compare the calculated variation width with a preset variation width, and
determine, based on the comparison, that a time for replacement of the cleaning member is reached if the variation width is less than the preset variation width.

14. The robotic vacuum cleaner of claim 13, further comprising:
an output part configured to provide information about the time for replacement to a user,
wherein the controller is configured to output, via the output part, information about the time for replacement when the controller determines that the time for replacement is reached.

15. A method for controlling a robotic vacuum cleaner, comprising:
rotating a rotation part of the robotic vacuum cleaner;
emitting light to a cleaning member provided with a reflective pattern through an optical sensor (180) and detecting an amount of light reflected from the cleaning member through the optical sensor;
detecting a pattern change in the light reflection amount by the reflective pattern based on the light reflection amount detected by the optical sensor; and
determining a state of the cleaning member based on the detected pattern change.

16. The method of claim 15, further comprising:
calculating an average and a standard deviation of values of the light reflection amount measured by the optical sensor over a predetermined time,
comparing the calculated standard deviation with a preset standard deviation, and
determining the state of the cleaning member based on a result of the comparison.

17. The method of claim 15, further comprising:
counting, for a predetermined time, a number of times a value of light reflection amount received by the optical sensor is less than a preset value,
comparing the counted number of times to a preset number of times, and
determining the state of the cleaning member based on a result of the comparison.

18. The method of claim 15, further comprising:
calculating a variation width between consecutive values of the light reflection amount by the optical sensor, and
determining a time for replacement of the cleaning member by comparing the calculated variation width with a preset variation width.

19. The method of claim of 15, further comprising:
providing information about the state of the cleaning member to a user via an output part.

20. A cleaning member detachably coupled to a robotic vacuum cleaner, comprising:
a main body including a surface having a first reflectance, and
a reflective pattern on the surface and having a second reflectance different from the first reflectance.
